(19) United States
(12) Patent Application Publication
(10) Pub. No.: US 2012/0009493 A1
(43) Pub. Date: Jan. 12, 2012

(54) COMPRESSION OF DIRECT METHANOL FUEL CELL STACKS WITH CATALYST COATED MEMBRANES AND MEMBRANE ELECTRODE ASSEMBLY

(75) Inventors: Bhaskar Sompalli, Fremont, CA (US); Paul Knauer, Fremont, CA (US); Derek Kwok, Fremont, CA (US)

(73) Assignee: OORJA PROTONICS INC., Fremont, CA (US)

(21) Appl. No.: 13/178,667

(22) Filed: Jul. 8, 2011

Related U.S. Application Data
(60) Provisional application No. 61/363,048, filed on Jul. 9, 2010.

(51) Int. Cl. H01M 8/04; H01M 8/10; H01M 2/08

(52) U.S. Cl. 429/429; 429/508; 429/480

(57) ABSTRACT

An apparatus to control a swelling of a catalyst coated membrane in a fuel cell includes an insulator layer provided at a perimeter of the fuel cell. The insulator layer has a plurality of insulator films and is secured to a flow field plate. The insulator layer has a less compressibility relative to a gasket used in the fuel cell. A method for controlling a swelling of a catalyst coated membrane in a fuel cell includes providing an insulator layer at a perimeter of each of fuel cells in a fuel cell stack. The fuel cell stack is compressed for a predetermined duration when the catalyst coated membrane is in a substantially dry state. Passage of fuel is allowed inside the fuel cell thereby facilitating the catalyst coated membrane to swell. A swollen catalyst coated membrane is allowed to contact the insulator layer.

### CROSS REFERENCE TO RELATED APPLICATION

This application claims priority from U.S. Provisional Application No. 61/363,048, filed on Jul. 9, 2010, the complete disclosure of which is incorporated fully herein by reference.

### TECHNICAL FIELD

The embodiments herein generally relate to fuel cell stacks, and, more particularly, but not exclusively, to fuel cells employing an apparatus and a method for controlling swelling of a catalyst coated membrane and a MEA.

### BACKGROUND

A fuel cell, like an ordinary battery, provides direct current electricity from two electrochemical reactions. The electrochemical reactions occur at electrodes to which reactants are fed. A fuel cell stack typically includes a series of individual fuel cells. Each cell includes an anode and a cathode. A voltage across each cell is determined by the type of electrochemical reaction occurring in the cell. For example, for a typical direct methanol fuel cell (DMFC), the voltage can vary from 0.2 V to 0.9 V, depending on a current being generated. The current being generated in the cell depends on the operating condition and design of the cell, such as electro-catalyst composition or distribution and active surface area of a membrane electrode assembly (MEA), characteristics of a gas diffusion layer (GDL), anode and cathode flow field designs, cell temperature, reactant concentration, reactant flow and pressure distribution, reaction by-product removal, and so forth. A reaction area of a cell, number of cells in series, and the type of electrochemical reaction in the fuel cell stack determine the current and hence the power supplied by the fuel cell stack. For example, typical power for a direct methanol fuel cell (DMFC) stack can range from a few watts to a few kilowatts. A fuel cell system typically integrates a fuel cell stack with different subsystems for the management of water, fuel, air, humidification, and thermal condition. These subsystems are sometimes collectively referred to as balance of the plant (BOP).

FIG. 1, illustrates a typical direct methanol fuel cell 10 (DMFC). As illustrated in FIG. 1, the direct methanol fuel cell 10 (DMFC) has a negative electrode 12a (anode), a positive electrode 12c (cathode), a catalyst coated membrane 12m, an anode flow field plate 13a and a cathode flow field plate 13b. The anode 12a is maintained by supplying a fuel such as a liquid methanolic solution (e.g., having a concentration in the range of 0.5 M to 5 M) and the cathode 12c is maintained by supplying oxygen or air. When providing a current, methanol is electrochemically oxidized at an anode electro-catalyst to produce electrons. The electrons travel through an external circuit (not shown) to a cathode electro-catalyst where the electrons are consumed together with oxygen in a reduction reaction. A circuit is maintained within the direct methanol fuel cell 10 (DMFC) by the conduction of protons in the catalyst coated membrane 12m. The catalyst coated membrane 12m is typically formed of a perfluorosulfonic acid (PFSA)-based material, such as a material sold under the trademark Nafion®. The catalyst coated membrane 12m is proton-conducting and typically requires humidification to operate efficiently. The effectiveness of the catalyst coated membrane 12m depends on gas diffusion layers G which are in communication with the catalyst coated membrane 12m for electronic contact and for aiding mass transport of reactants and by-products. The gas diffusion layer G allows access to methanolic solution and remove carbon dioxide CO2 gas formed at the anode 12a side. At the cathode 12c side, the gas diffusion layer G allows access to air and remove water. The catalyst coated membrane 12m and the gas diffusion layers G operate efficiently when mass transport of reactants and by-products occurs smoothly. The effectiveness of the mass transport is typically affected by the degree of compression of the gas diffusion layers G, and other characteristics such as porosity and Teflon content. A certain degree of compression is desirable to reduce Ohmic resistances between the anode flow field plate 13a and the cathode flow field plate 13b, the gas diffusion layers G, and the catalyst coated membrane 12m. However, too high a compression can crush fibers forming the gas diffusion layers G and close pores through which mass transport occurs which may result in damage of the electrodes.

Further, when the catalyst coated membrane 12m formed of a PFSA-based material is included within the cell 10, the catalyst coated membrane 12m is typically compressed in a dry form along with the gas diffusion layers G and an elastomeric, compressible gasket 14, as illustrated in FIG. 2. The catalyst coated membrane 12m tends to swell from about 50% to about 120% (e.g., by volume), when subsequently contacted with a solvent-based fuel, such as a methanolic solution in conjunction with a higher temperature. Due to the presence of the gasket 14, membrane swell along the x-y directions (e.g., along a plane facing the flow field plate) is substantially impeded by the gasket 14. However, the catalyst coated membrane 12m will be free to swell along z-direction (e.g., vertically in FIG. 2) into any remaining free volume. Because of the compression of the gasket 14, the remaining free volume to accommodate membrane swell can be substantially localized in channel areas C, as illustrated in FIG. 3. For the direct methanol fuel cell 10 (DMFC) where a need for accommodation of the evolved CO2 and low pressure drops can lead to deep and wide anode channels, the free volume available for membrane swell can be relatively high (e.g., up to 500 ml in some stacks). In such case, membrane swell can cause undesirably high compressive forces to develop in the channel areas. These high compressive forces, in turn, can lead to over-compression of the gas diffusion layers G, thus leading to undesirable mass transport restrictions and potentially damage at the anode 12a side. A similar situation could develop on the cathode 12c.

Therefore, there is a need to develop fuel cells employing an apparatus and a method for controlling swelling of a catalyst coated membrane.

### SUMMARY

In view of the foregoing, an embodiment herein provides an apparatus to control a swelling of a catalyst coated membrane in a fuel cell. The apparatus includes an insulator layer provided at a perimeter of the fuel cell. The insulator layer has a plurality of insulator films and is secured to a flow field plate. The insulator layer has a less compressibility relative to a gasket used in the fuel cell.

Embodiments further disclose a method for controlling a swelling of a catalyst coated membrane in a fuel cell includes providing an insulator layer at a perimeter of each of fuel cells in a fuel cell stack. The fuel cell stack is compressed for a predetermined duration when the catalyst coated membrane is in a substantially dry state. The method further includes allowing passage of fuel inside the fuel cell thereby facilitating the catalyst coated membrane to swell. The method also includes allowing swollen catalyst coated membrane to contact the insulator layer thereby preventing further swelling of said catalyst coated membrane.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIGS. 1-3 illustrate a typical direct methanol fuel cell;

FIG. 4 illustrates a portion of a fuel cell according to an embodiment of the invention; and

FIG. 5 is a perspective view of the fuel cell of FIG. 4 according to an embodiment.

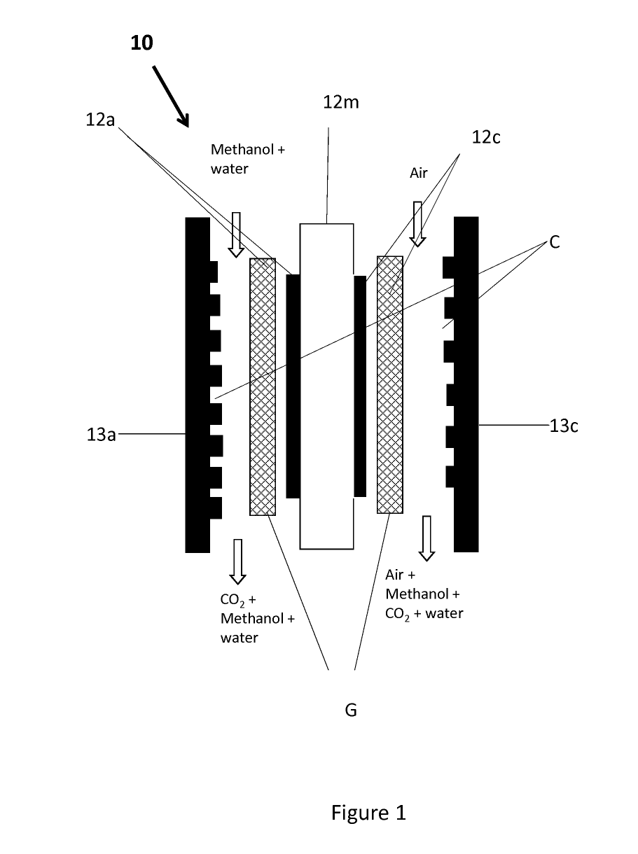

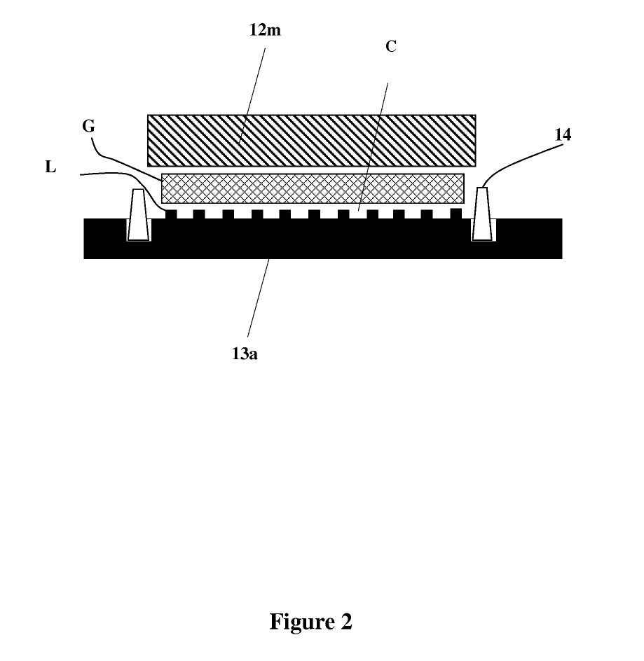

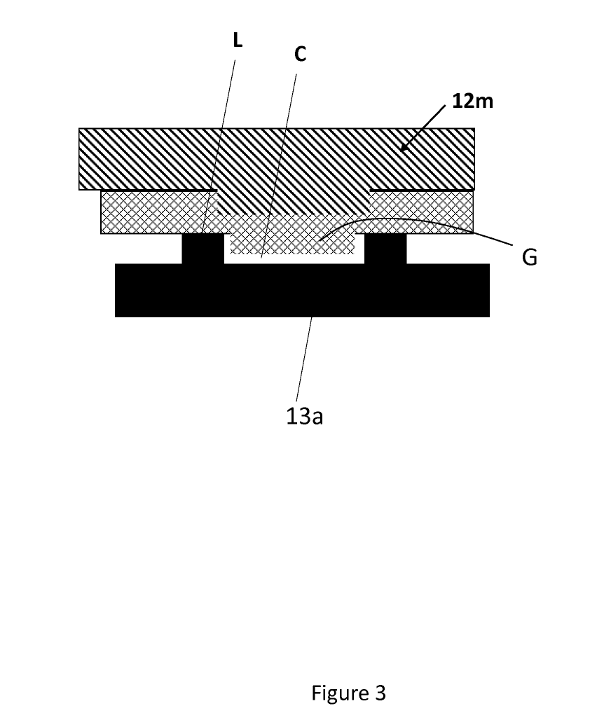

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

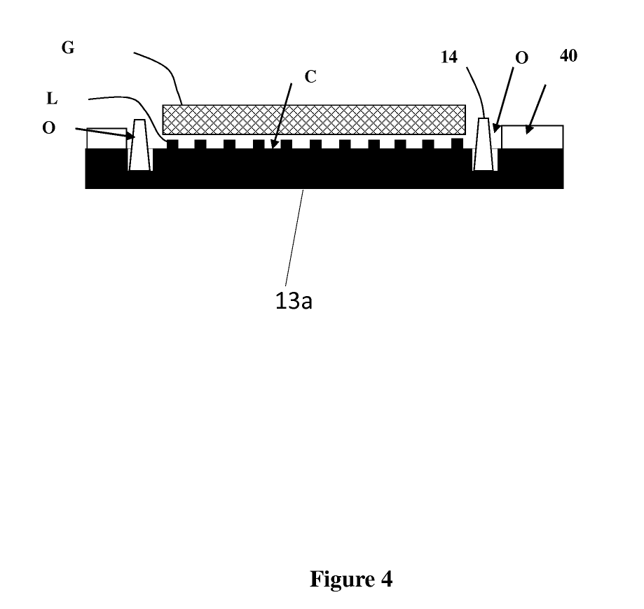

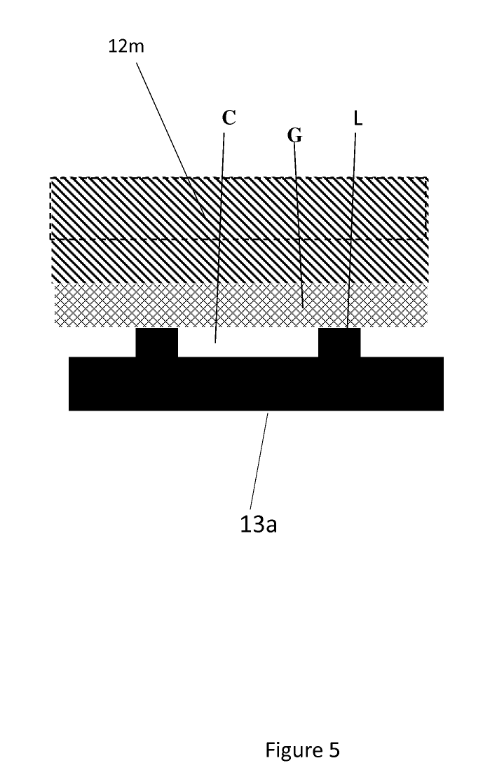

The embodiments herein disclose an apparatus and a method for controlling swelling of a catalyst coated membrane in a fuel cell. Referring now to the drawings, and more particularly to FIGS. 4 and 5, where similar reference characters denote corresponding features consistently throughout the figures, there are shown embodiments.

FIG. 4 illustrates a portion of a fuel cell 10 according to an embodiment of the invention. The fuel cell 10 according to FIG. 4 has an insulator layer 40 configured to be located at a perimeter of the fuel cell 10. The insulator layer 40 can be formed of any appropriate insulator material. The insulator layer 40 may be secured to the flow field plate 13a of the fuel cell 10 by any securing means known in the art. Further, the insulator layer 40 defines an opening O surrounding a compressible, elastomeric gasket 14. The insulator layer 40 has reduced compressibility as compared with the gasket 14. In an embodiment, the insulator layer 40 may include a plurality of insulator films.

Information regarding the expected swelling of the catalyst coated membrane 12m in solution can be gathered beforehand. Given the expected membrane swell, compensation for the swell is made by setting a thickness of the insulator layer 40 based on, or corresponding to, a thickness of the swollen catalyst coated membrane 12m. The thickness of the insulator layer 40 can also take into account a desired gas diffusion layer G compression for smooth mass transport and low contact resistance. In such manner, the insulator layer 40 serves as a hard-stop to avoid over-compression of gas diffusion layers G. Nafion 115 and a hydrocarbon membrane were analyzed and tabulated. The values relating to membrane swelling in x, y, and z direction at 1M and 8M methanol, 80° C. is given below in table 1.

TABLE 1

| | |
|---|---|
| Nafion 115 | Hydrocarbon membrane |

| | z | x | y | z | x | y |
|---|---|---|---|---|---|---|
| 1M MeOH | 19 | 17 | 21 | 4 | 7 | 9 |
| 1M MeOH | 31 | 23 | 31 | 31 | 13 | 14 |

When assembling a fuel cell stack, the stack is initially compressed at a relatively low load based on the thickness of the insulator layer 40. At this point, the catalyst coated membrane 12m is substantially dry. Once the stack is assembled, a methanolic solution flows into the anode 12a side, while maintaining the stack within a desired temperature range. The catalyst coated membrane 12m swells and pushes against the gas diffusion layer G, thereby compressing the gas diffusion layer G in-situ. The gas diffusion layer G, upon being pushed by the swollen catalyst coated membrane 12m, contacts a plurality lands/ribs L provided on the flow field plate 13a.

Further, as there is adequate free volume provided by the insulator layer 40, there is reduced channel intrusion of the gas diffusion layer G as a result of membrane swell. The stack is thereafter compressed to a final load in one or more subsequent compression operations. As catalyst coated membrane 12m is already swollen, and a thickness of the compressed gas diffusion layers G is therefore set, subsequent compression operations reduce the contact resistance, while creating little or no mass transport restrictions in the channel areas C. The effect of the insulator layer 40 on membrane swell is illustrated in FIG. 5. Advantageously, step-wise compression operations such as 750, 1000 Lb, 1250 in combination with the insulator layer 40, also serve to desensitize the stack to variations in compressibility and thickness of the gasket.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. An apparatus to control a swelling of a catalyst coated membrane in a fuel cell, said apparatus comprising:
an insulator layer provided at a perimeter of the fuel cell.

2. The apparatus as claimed in claim 1, wherein said insulator layer comprises a plurality of insulator films.

3. The apparatus as claimed in claim 1, wherein said insulator layer has a less compressibility relative to a gasket used in the fuel cell.

4. The apparatus as claimed in claim 3, wherein said insulator layer defines an opening to receive the gasket therein.

5. The apparatus as claimed in claim 4, wherein said insulator layer is secured to at least one flow field plate.

6. A method for controlling a swelling of a catalyst coated membrane in a fuel cell, said method comprising:
providing an insulator layer at a perimeter of each of fuel cells in a fuel cell stack;
compressing said fuel cell stack for a predetermined duration when said catalyst coated membrane is in a substantially dry state;
allowing passage of fuel inside the fuel cell thereby facilitating said catalyst coated membrane to swell; and
allowing said swollen catalyst coated membrane to contact said insulator layer thereby preventing further swelling of said catalyst coated membrane.

7. The method as claimed in claim 6, wherein allowing said swollen catalyst coated membrane to contact said insulator layer includes allowing a gas diffusion layer to contact a plurality of ribs provided on a respective flow field plate.

8. The method as claimed in claim 6 further comprising, compressing said fuel cell stack after allowing said swollen catalyst coated membrane to contact said insulator layer.

9. The method as claimed in claim 6, wherein the insulator layer includes a plurality of insulator films.

10. A fuel cell comprising:
a catalyst coated membrane; and
an apparatus to control swelling of said catalyst coated membrane,
wherein said apparatus comprises an insulator layer provided at a perimeter of said fuel cell.

11. The apparatus as claimed in claim 10, wherein said insulator layer comprises a plurality of insulator films.

12. The apparatus as claimed in claim 10, wherein said insulator layer has a less compressibility relative to a gasket used in the fuel cell.

13. The apparatus as claimed in claim 12, wherein said insulator layer defines an opening to receive the gasket therein.

14. The apparatus as claimed in claim 13, wherein said insulator layer is secured to at least one flow field plate.
